(19) United States
(12) Patent Application Publication
(10) Pub. No.: US 2025/0323714 A1
(43) Pub. Date: Oct. 16, 2025

(54) ENHANCED IDLE MODE BEHAVIOR OF NETWORK CONTROLLED REPEATERS

(71) Applicant: QUALCOMM Incorporated, San Diego, CA (US)

(72) Inventors: Sourjya DUTTA, San Diego, CA (US); Navid ABEDINI, Basking Ridge, NJ (US); Kapil GULATI, Belle Mead, NJ (US)

(21) Appl. No.: 18/633,345

(22) Filed: Apr. 11, 2024

(51) Int. Cl. H04B 7/185

(52) U.S. Cl. CPC H04B 7/18513

(57) ABSTRACT

Methods, systems, and devices for wireless communications are described. A network-controlled repeater (NCR) may enter an idle mode at a first radio (e.g., an NCR mobile termination (NCR-MT)) associated with the NCR. The NCR may forward, via a second radio (e.g., an NCR forwarder (NCR-FWD)) associated with the NCR, one or more transmissions of a downlink control information (DCI), a paging early indication (PEI), or both during a paging occasion of a paging frame while the first radio is in the idle mode. The NCR may selectively forward, via the second radio associated with the NCR, one or more paging messages or physical downlink shared channel (PDSCH) transmissions during a set quantity of symbols of the paging frame subsequent to the paging occasion while the first radio is in the idle mode. The selective forwarding may be based on successfully decoding the DCI or the PEI at the NCR.

### FIELD OF TECHNOLOGY

The following relates to wireless communications, including enhanced idle mode behavior of network controlled repeaters (NCRs).

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

A network entity (e.g., a base station) may extend coverage to one or more additional UEs by communicating with a repeater that may forward one or more messages from the network entity to the one or more additional UEs.

### SUMMARY

The described techniques relate to improved methods, systems, devices, and apparatuses that support enhanced idle mode behavior of network-controlled repeaters (NCRs). For example, the described techniques provide for an NCR to selectively forward messages from a network entity to one or more user equipments (UEs). The NCR may include a first radio that may be referred to as an NCR mobile termination (NCR-MT) and a second radio that may be referred to as an NCR forwarder (NCR-FWD). In some examples, the NCR may enter an idle mode at the NCR-MT and may periodically wake up to monitor a paging occasion of a paging frame for a paging early indication (PEI) or a downlink control information (DCI) indicating a scheduled physical downlink shared channel (PDSCH) transmission during a set quantity of symbols of the paging frame. The NCR-MT may stay awake for a set quantity of symbols to detect and decode the DCI. Rather than unconditionally forwarding all of the set quantity of symbols of the paging frame, the NCR-FWD may selectively forward the PDSCH in the set quantity of symbols of the paging frame based on successfully decoding the DCI or based on the PEI.

### BRIEF DESCRIPTION OF THE DRAWINGS

FIG. 1 shows an example of a wireless communications system that supports enhanced idle mode behavior of network-controlled repeaters (NCRs) in accordance with one or more aspects of the present disclosure.

FIG. 2 shows an example of a signaling diagram that supports enhanced idle mode behavior of NCRs in accordance with one or more aspects of the present disclosure.

FIG. 3 shows an example of a signaling diagram that supports enhanced idle mode behavior of NCRs in accordance with one or more aspects of the present disclosure.

FIG. 4 shows an example of a resource diagram that supports enhanced idle mode behavior of NCRs in accordance with one or more aspects of the present disclosure.

FIG. 5 shows an example of a process flow that supports enhanced idle mode behavior of NCRs in accordance with one or more aspects of the present disclosure.

FIGS. 6 and 7 show block diagrams of devices that support enhanced idle mode behavior of NCRs in accordance with one or more aspects of the present disclosure.

FIG. 8 shows a block diagram of a communications manager that supports enhanced idle mode behavior of NCRs in accordance with one or more aspects of the present disclosure.

FIG. 9 shows a diagram of a system including a device that supports enhanced idle mode behavior of NCRs in accordance with one or more aspects of the present disclosure.

FIGS. 10 and 11 show flowcharts illustrating methods that support enhanced idle mode behavior of NCRs in accordance with one or more aspects of the present disclosure.

### DETAILED DESCRIPTION

In some wireless communication systems, a network-controlled repeater (NCR) may repeat (e.g., amplify and forward) signals between a network entity and one or more user equipments (UEs), e.g., to improve network coverage and to support an increased quantity of UEs. Some NCRs may use intelligence received via control signaling from the network to decide whether to forward transmissions, which may be especially useful in coverage extension for beam-based communications (e.g., communications using millimeter wave bands, including frequencies within the 3GPP Frequency Range 2 (FR2)) without requiring new base station (e.g., gNB) installations. An intelligent NCR may include two radios: an NCR mobile terminal (NCR-MT) and an NCR-forwarder (NCR-FWD). The NCR-MT may be connected to the network entity via a control link and may transmit and receive control signaling related to forwarding operations at the NCR. The NCR-FWD radio may be connected to the network entity via a backhaul link and may be connected to one or more UEs via one or more access links. In some examples, the NCR-MT may enter an idle (e.g., inactive, sleeping) state, and the NCR-FWD may continue to forward messages at a fixed schedule (e.g., a schedule provided by the network entity prior to the NCR-MT entering the idle mode). For example, the NCR-FWD may forward all paging occasions even when no paging message is sent to the one or more UEs connected to the NCR-FWD. It may be desirable to further enhance NCR operations while the NCR-MT is in idle mode to save power and operational costs at the operator side by reducing unnecessary forwarding on paging occasions.

In some implementations of the principles of this disclosure, the NCR-MT may enter the idle mode and may periodically wake up to monitor a paging occasion of a paging frame for a paging early indication (PEI) or a downlink control information (DCI) indicating a scheduled physical downlink shared channel (PDSCH) transmission during a set quantity of symbols of the paging frame. The NCR-MT may stay awake for a set quantity of symbols to detect and decode the DCI. Rather than unconditionally forwarding all of the set quantity of symbols of the paging frame, the NCR-FWD may selectively forward the PDSCH in the set quantity of symbols of the paging frame based at least in part on successfully decoding the DCI or based on the PEI.

In some examples, the NCR may receive an indication of one or more identifiers (IDs) associated with one or more UEs (e.g., UEs connected to the NCR-FWD via an access link). In cases where the paging frame may contain multiple paging occasions, the NCR may unconditionally forward a first set of paging occasions associated with a first ID of the one or more IDs and selectively forward a second set of paging occasions associated with a second ID of the one or more IDs based at least in part on the received indication. In some examples, the NCR may unconditionally forward a first set of paging occasions and selectively forward a second set of paging occasions based at least in part on an ID associated with the NCR.

In some examples, the NCR may forward paging signaling (e.g., the PEI, the DCI, the one or more paging messages, or the PDSCH transmission) at a first slot on a first beam and may forward a retransmission of the paging signaling at a second slot on a second beam, where the first slot and the second slot are separated by an offset value.

By selectively forwarding messages (e.g., refraining from forwarding one or more paging occasions), the NCR may reduce power consumption and operational costs at the NCR, while more efficiently utilizing communication resources, reducing latency, improving coordination between devices, and extending battery life of devices connected through it.

Aspects of the disclosure are initially described in the context of wireless communications systems. Aspects of the disclosure are then described in the context of signaling diagrams, a resource diagram, and a process flow. Aspects of the disclosure are further illustrated by and described with reference to apparatus diagrams, system diagrams, and flowcharts that relate to enhanced idle mode behavior of network controlled repeaters.

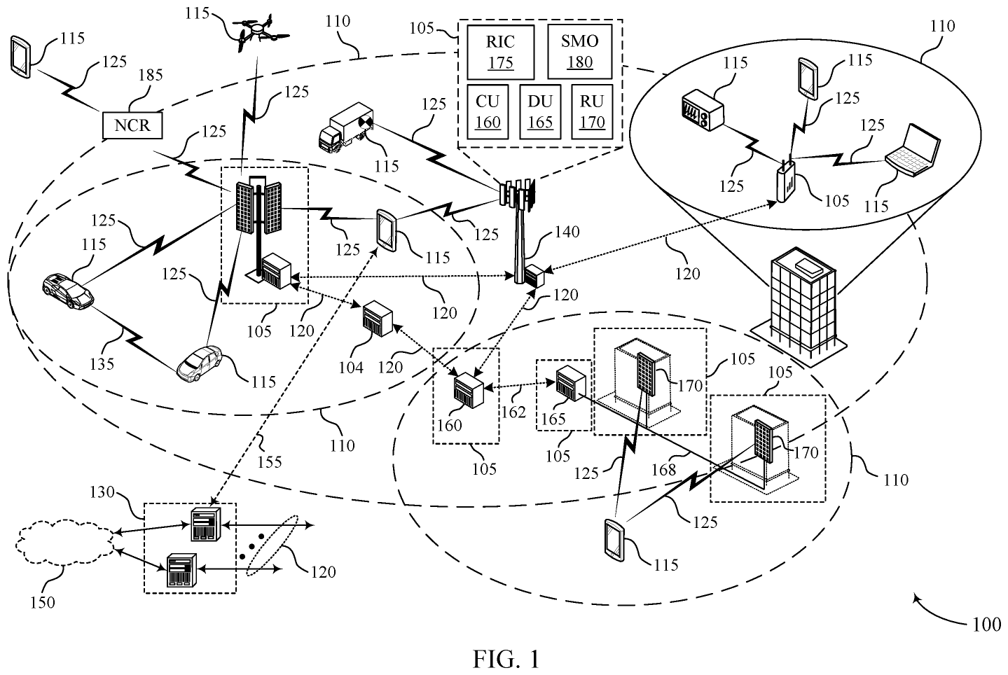

FIG. 1 shows an example of a wireless communications system 100 that supports enhanced idle mode behavior of network controlled repeaters in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

In the case of the techniques described herein applied in the context of a disaggregated RAN architecture, one or more components of the disaggregated RAN architecture may be configured to support test as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 may include entering a power saving deep sleep mode when not engaging in active communications, operating using a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by a transmitting device (e.g., a network entity 105 or a UE 115) along a single beam direction (e.g., a direction associated with the receiving device, such as another network entity 105 or UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a transmitting device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

In the wireless communication system 100, a repeater (e.g., a dumb repeater) may repeat (e.g., amplify and forward) signals between a network entity 105 and one or more UEs 115, e.g., to improve network coverage and to support an increased quantity of UEs 115. Some repeaters, which may be referred to as network controlled repeaters (NCRs) 185, may use intelligence received via control signaling from the network entity 105 (e.g., via a communication link 125) to decide whether to forward transmissions, which may be especially useful in coverage extension for beam-based applications (e.g., mmWave or FR2 or a beamformed access context where traditional dumb repeaters generally are limited) without requiring new base station (e.g., gNB, or another network entity 105) installations. That is, an NCR 185 may reduce operational costs and minimize coverage holes without requiring gNB installations compared to a dumb repeater. Saving power at the NCR 185 may also lead to network energy savings.

An intelligent NCR 185 may include two radios. A first radio within the NCR 185 may be an NCR-MT that may be connected to the network entity 105 via a communication link 125 (e.g., a control link) and may provide intelligence to the NCR 185. A second radio within the NCR 185 may be an NCR-FWD, and may be connected to the network entity 105 via a communication link 125 (e.g., a backhaul link) and may be connected to one or more UEs 115 via one or more communication links 125 (e.g., access links). In some examples, the NCR-MT may be in an idle (e.g., inactive, sleeping) state, and the NCR-FWD may forward messages at a fixed schedule (e.g., provided by the network entity prior to the NCR-MT going to sleep). For example, the NCR-FWD may forward all paging occasions even when no paging message is sent to the one or more UEs 115. NCR 185 enhancements to save power and operational costs at the operator side by reducing unnecessary forwarding on paging occasions may be desired.

In some implementations, the NCR 185 can go into a power saving mode, by transitioning the NCR-MT to an RRC idle mode and periodically waking up to monitor a paging occasion of a paging frame for a PEI or a DCI indicating a scheduled PDSCH transmission during a set quantity of symbols of the paging frame. The NCR-MT may stay awake for a set quantity of symbols to detect and decode the DCI. Rather than unconditionally forwarding all of the set quantity of symbols of the paging frame, the NCR-FWD may selectively forward the PDSCH in the set quantity of symbols of the paging frame based at least in part on successfully decoding the DCI or based on the PEI.

In some examples, the NCR 185 may receive an indication of one or more IDs associated with one or more UEs 115 (e.g., UEs 115 connected to the NCR 185 via the communication link 125). In cases where the paging frame may contain multiple paging occasions, the NCR 185 may unconditionally forward a first set of paging occasions associated with a first ID of the one or more IDs and selectively forward a second set of paging occasions associated with a second ID of the one or more IDs based at least in part on the received indication. In some examples, the NCR 185 may unconditionally forward a first set of paging occasions and selectively forward a second set of paging occasions based at least in part on an ID associated with the NCR 185.

In some examples, the NCR 185 may forward paging signaling (e.g., the PEI, the DCI, the one or more paging messages, or the PDSCH transmission) at a first slot on a first beam and may forward a retransmission of the paging signaling at a second slot on a second beam, where the first slot and the second slot are separated by an offset value.

By selectively forwarding messages (e.g., refraining from forwarding one or more paging occasions), the NCR 185 may reduce power consumption and operational costs at the NCR 185 while maintaining performance.

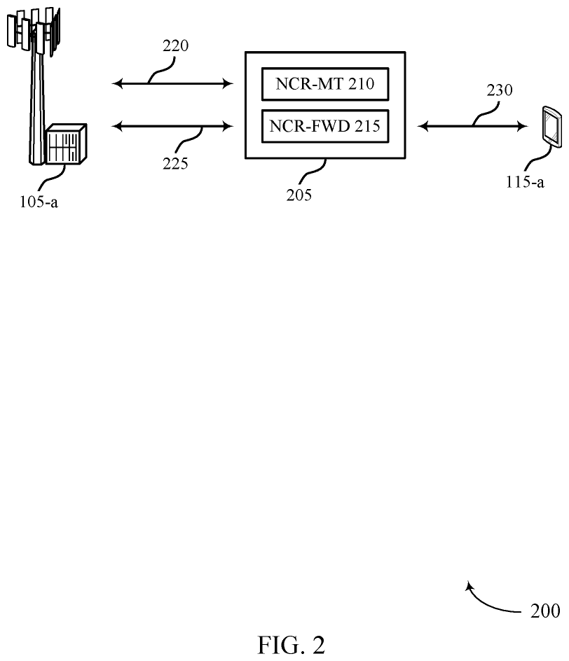

FIG. 2 shows an example of a signaling diagram 200 that supports enhanced idle mode behavior of NCRs in accordance with one or more aspects of the present disclosure. In some examples, the signaling diagram 200 may implement aspects of the wireless communications system 100. For example, the signaling diagram 200 includes a UE 115-a, an NCR 205, and a network entity 105-a, which may be examples of the corresponding devices described with reference to FIG. 1 (e.g., the NCR 185). Additionally, or alternatively, the UE 115-a, the network entity 105-a, and the NCR 205 may each be examples of other types of wireless devices, such as an IAB node or another type of transmitter or receiver. Thus, although aspects of the present disclosure are described with reference to a UE 115, a network entity 105, and an NCR 205, it is understood that the described techniques may be performed by a wireless device different from a UE 115, a network entity 105, and an NCR 205. As described herein, operations performed by the UE 115-a, the network entity 105-a, and the NCR 205 may be respectively performed by a UE 115, a network entity 105, an NCR 185, or another wireless device, and the examples shown should not be construed as limiting.

Devices in the signaling diagram 200 may support an enhanced idle mode at the NCR 205. For example, the NCR 205 may include an NCR-MT 210 and an NCR-FWD 215. The NCR 205 may enter a power-saving mode (e.g., an enhanced idle mode, an inactive mode) by transitioning the NCR-MT 210 from RRC-connected mode to RRC-Idle/Inactive mode. The enhanced idle mode may further reduce the time that the NCR-FWD 215 is turned on while the NCR-MT 210 is in the idle or inactive mode.

The NCR-MT 210 may communicate with the network entity 105-a via a control link 220. For example, the network entity 105-a may output (e.g., transmit) control signaling to the NCR-MT 210 via the control link 220. The NCR-FWD 215 may communicate with the network entity 105-a via a backhaul link 225. For example, the network entity 105-a may output (e.g., transmit) one or more PEIs, DCIs, PDSCHs, or other signaling to the NCR-FWD 215 via the backhaul link 225. In some examples, multiple UEs may be connected to the network via the NCR, and the NCR-FWD 215 may communicate with one or more UEs 115 (e.g., the UE 115-a) via one or more respective access links 230. That is, one or more UEs 115 (including the UE 115-a) may be connected to the network entity 105-a via the NCR 205. Some or all of the one or more UEs 115 may be in idle/inactive mode for a considerable period. The NCR 205, even in the idle/inactive state, may need to repeat paging information for one or more of the UEs 115. However, repeating all paging occasions without any intelligence may lead to increased power consumption at the NCR 205.

In some implementations, the NCR-MT 210 may, based on a network configuration and the idle mode operations of the NCR-MT 210, determine if one or more paging occasions of a set of multiple paging occasions needs to be repeated on the access link 230. Based on the determination, the NCR-MT 210 may turn off the NCR-FWD 215 for a part of the paging occasions.

In some cases, a paging frame may be configured with a single paging occasion. In a first example, while the NCR-MT 210 is in idle mode, the NCR 205 may forward every slot or subframe containing a PDCCH monitoring occasion. That is, the network entity 105-a may configure the NCR-FWD 215 (e.g., via RRC signaling, MAC control entity (MAC-CE), system information, or dynamic physical layer signaling) to forward on all slots containing PDCCH monitoring occasions in one or more paging frames while the NCR-MT 210 is in idle mode. In another example, while the NCR-MT 210 is in idle mode, the NCR-MT 210 (or the network entity 105-a) may activate the NCR-FWD 215 on one or more PDCCH monitoring occasions associated with one or more paging occasions. The NCR-FWD 215 may remain active for a set quantity of symbols (e.g., the next (symbols) following the PDCCH monitoring occasions. The NCR 205 may use the set quantity of symbols to detect or decode a DCI on the PDCCH occasions. The NCR 205 may conditionally (e.g., selectively) forward the remaining PDSCH based on if the NCR-MT 210 detects a DCI on the paging occasion.

In some cases, a paging frame may be configured with multiple paging occasions. In a first example, the network entity 105-a may configure the NCR-FWD 215 (e.g., via RRC signaling, MAC-CE, system information, or dynamic physical layer signaling) to forward on all slots or subframes containing PDCCH monitoring occasions in each paging occasion of the paging frame while the NCR-MT 210 is in idle mode. In a second example, the network entity 105-a may configure the NCR-FWD 215 (e.g., via RRC signaling, MAC-CE, system information, or dynamic physical layer signaling) to forward all paging occasions that the NCR 205 does not monitor and selectively forward paging occasions on which the NCR 205 monitors for PDCCH while the NCR-MT 210 is in idle mode. The NCR-MT 210 may determine which paging occasions to monitor (e.g., listen on) based on a UE ID of the NCR-MT 210 and the idle mode configuration of the NCR-MT 210. The NCR-MT 210 may determine the paging occasion to monitor based on an index iₛ, which may be determined based on the UE ID of the NCR-MT 210 and one or more constants. For example,

$${i}_{s} = ⌊ \frac{UE - ID}{N} ⌋ mod {N}_{s} .$$

In a third example, the network entity 105-a may configure the NCR 205 (e.g., via RRC signaling, MAC-CE, system information, or dynamic physical layer signaling) to selectively forward all paging occasions that the NCR 205 does not monitor and selectively forward paging occasions on which the NCR 205 monitors for PDCCH while the NCR-MT 210 is in idle mode. The NCR-MT 210 may determine which paging occasions to monitor (e.g., listen on) based on the UE ID of the NCR-MT 210 and a set of additional UE IDs. For example, the set of additional UE IDs may identify one or more UEs 115 (e.g., the UE 115-a) that have used (e.g., connected to, via an access link 230) the NCR 205 in the past and have moved into an idle mode. The set of additional UE IDs may be a set of discrete UE IDs (e.g., UE 1, UE 3, UE 4, and UE 6) or a range of UE IDs with a maximum and minimum UE ID value (e.g., all UEs from UE 2 through UE 5). In some examples, the NCR 205 may receive an indication of the set of additional UE IDs (e.g., from the network entity 105-a via the control link 220).

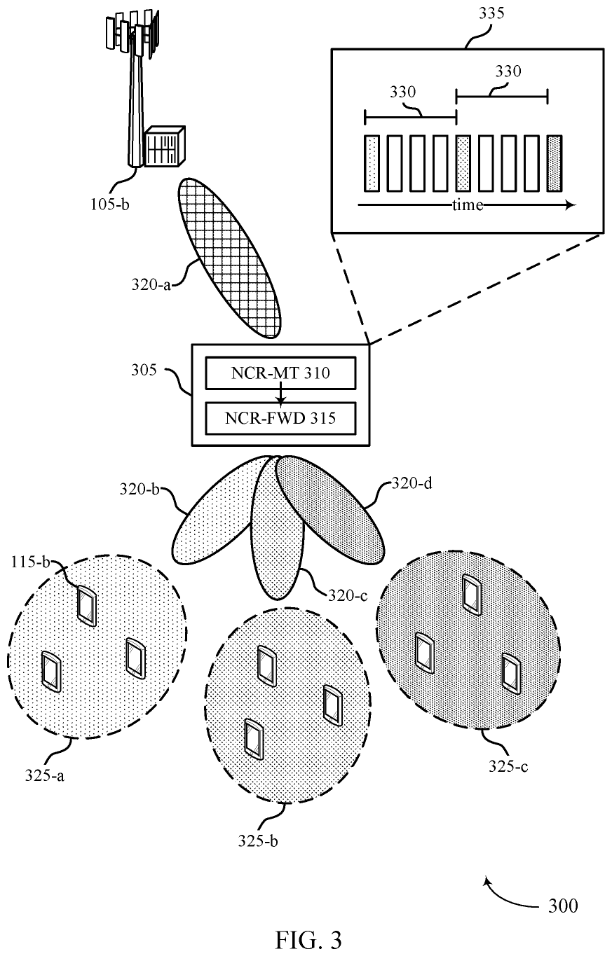

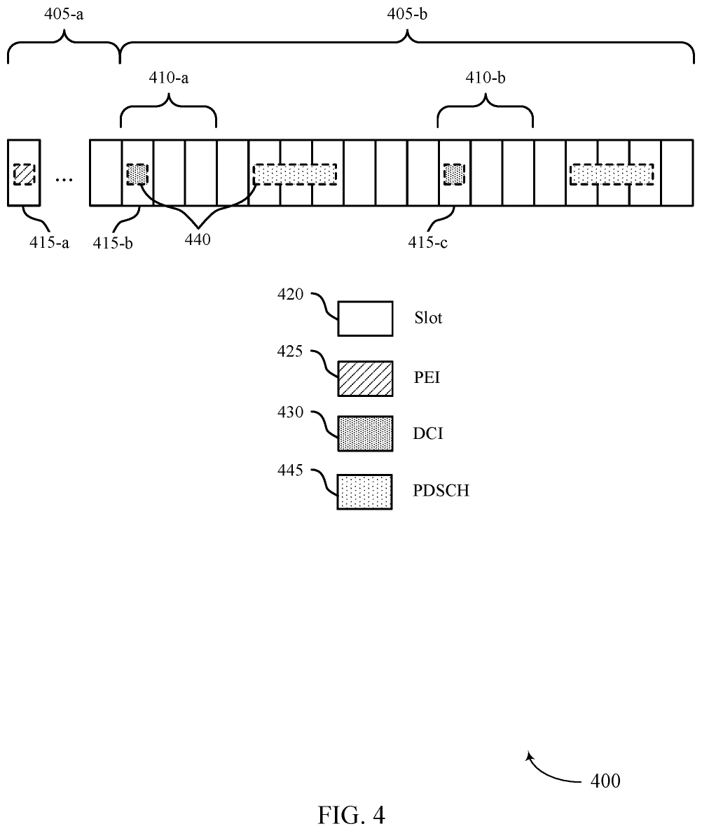

In some examples, the NCR 205 may forward one or more signals on one or more beams, as described in more detail with reference to FIG. 3. In some examples, the NCR may receive and forward a PEI, and may selectively forward one or more paging occasions based on the PEI, as described in more detail with reference to FIG. 4.

FIG. 3 shows an example of a signaling diagram 300 that supports enhanced idle mode behavior of NCRs in accordance with one or more aspects of the present disclosure. In some examples, the signaling diagram 300 may implement aspects of the wireless communications system 100 and the signaling diagram 200. For example, the signaling diagram 300 includes UE groups 325 (including a UE 115-b), an NCR 305 (including an NCR-MT 310 and an NCR-FWD 315), and a network entity 105-b, which may be examples of the corresponding devices described with reference to FIG. 1 and FIG. 2. Additionally, or alternatively, the UEs 115 in the UE groups 325, the network entity 105-b, and the NCR 305 may each be examples of other types of wireless devices, such as an IAB node or another type of transmitter or receiver. Thus, although aspects of the present disclosure are described with reference to a UE 115, a network entity 105, and an NCR 305, it is understood that the described techniques may be performed by a wireless device different from a UE 115, a network entity 105, and an NCR 305. As described herein, operations performed by the UE 115-a, the network entity 105-a, and the NCR 305 may be respectively performed by a UE 115, a network entity 105, or another wireless device, and the examples shown should not be construed as limiting.

Devices in the signaling diagram 300 may support multi-beam operations in an enhanced idle mode of the NCR 305. For beam-formed operations, a backhaul link may be repeated over multiple access link directions. The backhaul link may be an example of the backhaul link 225 described with reference to FIG. 2, and may connect the network entity 105-b to the NCR-FWD 315. The access link may be an example of the access link 230 described with reference to FIG. 2, and may connect the NCR-FWD 315 to one or more UEs 115 of a UE group 325, such as the UE 115-b of the UE group 325-a.

For example, the network entity 105-b may repeat paging information (e.g., a DCI and a PDSCH, a paging message, paging-related signaling) No times on a first beam 320-a to the NCR 305 at an interval K (e.g., an offset value 330). No may represent the quantity of UE groups 325 (e.g., N₀=3 as illustrated in FIG. 3, where the NCR 305 is connected to the UE group 325-a, the UE group 325-b, and the UE group 325-c). The network entity 105-b may configure (e.g., via RRC signaling, MAC-CE, system information, or dynamic physical layer signaling) the offset value 330 (e.g., the interval K) at the NCR-MT 310 for repeating paging-related signaling. As illustrated by the resource diagram 335, the offset value 330 may represent the timing offset (e.g., a quantity of slots or symbols) between a first transmission of a paging message and a subsequent retransmission of the paging message (or between a first retransmission and a second retransmission). In some examples, the first transmission of the paging message may be forwarded by the NCR-FWD 315 to one or more UEs 115 (e.g., the UE 115-b) in a first UE group 325-a via the beam 320-b, the first retransmission of the paging message may be forwarded by the NCR-FWD 315 to one or more UEs 115 in a second UE group 325-b via the beam 320-c, and the second retransmission of the paging message may be forwarded by the NCR-FWD 315 to one or more UEs 115 in a third UE group 325-c via the beam 320-d.

If the NCR-MT 310 conditionally (e.g., selectively) forwards a PDSCH of a paging occasion, and if the NCR-MT 310 detects a DCI on a PDCCH monitoring occasions, the NCR-MT 310 may unconditionally repeat the control and data associated with the PDCCH monitoring occasion K slots later (e.g., after the offset value 330).

FIG. 4 shows an example of a resource diagram 400 that supports enhanced idle mode behavior of NCRs in accordance with one or more aspects of the present disclosure. The resource diagram 400 may implement or be implemented by one or more aspects of the wireless communications system 100, the signaling diagram 200, and the signaling diagram 300 described with reference to FIGS. 1, 2, and 3, respectively. For example, the resource diagram 400 may be implemented by a network entity 105, an NCR 205 or NCR 305, and a UE 115 as described with reference to FIGS. 1 and 2 to support enhanced idle mode behavior of an NCR.

For example, the resource diagram 400 may be utilized after an NCR has entered an idle mode at a first radio (e.g., an NCR-MT) associated with the NCR. The NCR may forward, via a second radio (e.g., an NCR-FWD) associated with the NCR, one or more transmissions of a PEI 425 during a paging occasion 415-a of a paging frame 405-a while the first radio is in the idle mode. The PEI 425 may indicate to the NCR to wake up for reception and decoding of a paging message 440 in one or more subsequent slots 420 or symbols. The paging message 440 may include a DCI 430, a PDSCH 445, or both. In some examples, the paging message 440 may include a DCI Format 1_0 addressed to a temporary paging ID (e.g., a paging radio network temporary identifier (RNTI)) of a UE 115, which schedules a PDSCH 445 containing the content of the paging message 440. For example, the PDSCH may contain RRC-level paging information so that the UE 115 can exit an idle mode, connect to the cell, and receive data from the network entity 105.

In some examples, the NCR may receive the paging message 440 in a second paging frame 405-b (although in some examples, the NCR may receive the PEI 425 and the paging message 440 in a same paging frame 405-a). The NCR may wake up (e.g., in response to the PEI 425) at the paging occasion 415-b (e.g., a PDCCH monitoring occasion) to monitor for the DCI 430. The NCR may remain awake or active during a DCI detection window 410-a (e.g., the next (symbols, or a set quantity of symbols or slots 420) to detect or decode the DCI 430. For example, the DCI detection window 410-a may be 3 symbols of slots 420 (e.g., [symbol] =3).

In some examples, if the NCR forwards the paging occasion 415-b (e.g., per a network configuration received via RRC signaling, MAC-CE, system information, or dynamic physical layer signaling), the NCR may also forward the associated PEI 425 (e.g., the paging occasion 415-a).

If the NCR-MT is configured to receive a PEI 425, the NCR-MT may use one of several methods to determine which paging occasions 415 to forward to one or more UEs 115. In some cases, the paging frame 405-b may be configured with a single paging occasion 415-b. In a first example, the NCR may forward every slot 420 or subframe containing a PDCCH monitoring occasion (e.g., irrespective of the PEI 425) while the NCR-MT is in idle mode. That is, the network entity 105 may configure the NCR-FWD (e.g., via RRC signaling, MAC-CE, system information, or dynamic physical layer signaling) to forward on all slots 420 containing PDCCH monitoring occasions in the paging frame 405-b. In this case, the NCR-MT may use the PEI 425 to determine if the NCR-MT may decode the paging occasion 415 associated with its own UE ID or group ID. In another example, while the NCR-MT is in idle mode, the NCR-MT (or the network entity 105) may activate the NCR-FWD on one or more PDCCH monitoring occasions associated with one or more paging occasions 415. The NCR may conditionally (e.g., selectively) forward the remaining PDSCH 445 based on if the NCR-MT detects a DCI 430 on the paging occasion 415-b, or in the DCI detection window 410-a. That is, the NCR may selectively forward the paging message 440 (e.g., the DCI 430 and the PDSCH 445) during a set quantity of symbols or slots 420 of the paging frame 405-b subsequent to the paging occasion 415-b while the NCR-MT is in idle mode.

In some cases, the paging frame 405-b may be configured (e.g., via RRC signaling, MAC-CE, system information, or dynamic physical layer signaling) with multiple paging occasions 415 (e.g., the paging occasion 415-b and the paging occasion 415-c). That is, the UE 115 may monitor for DCI in a first DCI detection window 410-a and in a second DCI detection window 410-b. In a first example, the network entity 105 may configure the NCR-FWD (e.g., via RRC signaling, MAC-CE, system information, or dynamic physical layer signaling) to forward on all slots 420 or subframes containing PDCCH monitoring occasions in each paging occasion 415 of the paging frame 405-b while the NCR-MT is in idle mode. In a second example, the network entity 105 may configure the NCR-FWD (e.g., via RRC signaling, MAC-CE, system information, or dynamic physical layer signaling) to forward all paging occasions 415 that the NCR does not monitor and selectively forward paging occasions 415 on which the NCR monitors for PDCCH while the NCR-MT is in idle mode. The NCR-MT may determine which paging occasions 415 to monitor (e.g., listen on) based on a UE ID of the NCR-MT and the idle mode configuration of the NCR-MT. The NCR-MT may determine the paging occasions 415 to monitor based on an index iₛ, which may be determined based on the UE ID of the NCR-MT and one or more constants. For example,

$${i}_{s} = ⌊ \frac{UE - ID}{N} ⌋ mod {N}_{s} .$$

In a third example, the network entity 105 may configure the NCR (e.g., via RRC signaling, MAC-CE, system information, or dynamic physical layer signaling) to selectively forward all paging occasions 415 that the NCR does not monitor and selectively forward paging occasions 415 on which the NCR monitors for PDCCH while the NCR-MT is in idle mode. The NCR-MT may determine which paging occasions 415 to monitor (e.g., listen on) based on the UE ID of the NCR-MT and a set of additional UE IDs. For example, the set of additional UE IDs may identify one or more UEs 115 that have used (e.g., connected to, via an access link) the NCR in the past and have moved into an idle mode. The set of additional UE IDs may be a set of discrete UE IDs (e.g., UE 1, UE 3, UE 4, and UE 6) or a range of UE IDs with a maximum and minimum UE ID value (e.g., all UEs from UE 2 through UE 5).

The PEI 425 may indicate the set of additional UE IDs. For example, the PEI 425 may indicate a first UE ID of the set of additional UE IDs associated with the paging occasion 415-b. The NCR may selectively forward the paging occasion 415-b based on the paging occasions 415-b being associated with the first UE ID indicated by the PEI 425. The NCR may unconditionally forward (or refrain from forwarding) the paging occasion 415-c based on a second UE ID associated with the paging occasion 415-c being absent in the PEI 425. In some examples, the PEI 425 may indicate one or more group IDs associated with one or more respective paging occasions 415, where each group ID may identify a group of UEs connected to the NCR via an access link. The NCR may forward one or more paging occasions 415 associated with one or more group IDs indicated by the PEI 425.

In some examples, the network entity 105 may indicate a set-Y of UE IDs or group IDs associated with the NCR (e.g., in addition to the PEI 425 indicating the set of additional UE IDs). The NCR may forward one or more paging occasions 415 if the associated UE ID or group ID is indicated in the PEI 425 and is present in the set-Y indicated by the network.

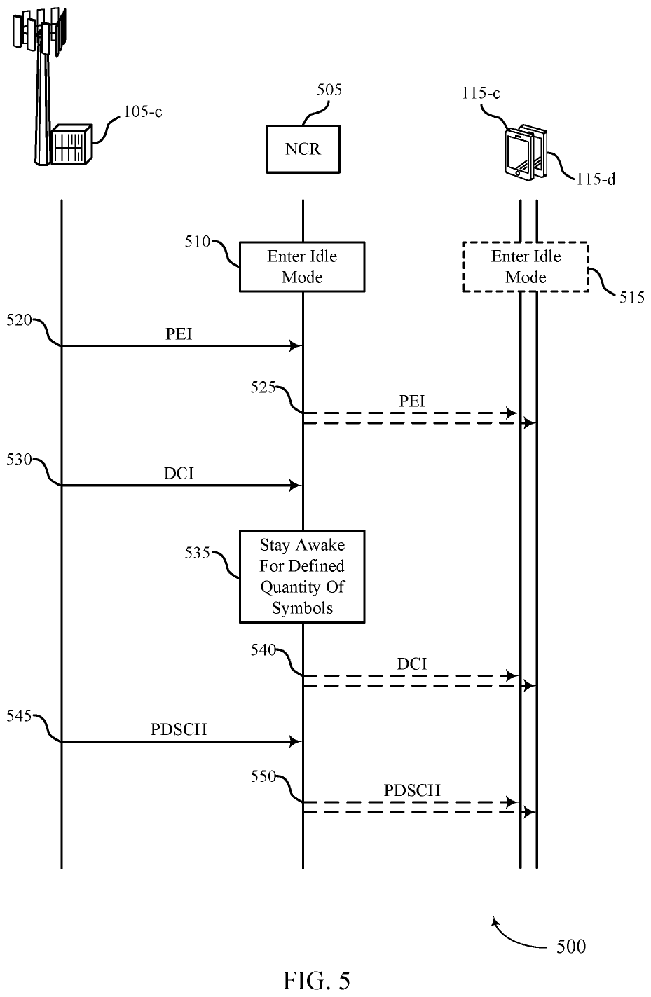

FIG. 5 shows an example of a process flow 500 that supports enhanced idle mode behavior of network controlled repeaters in accordance with one or more aspects of the present disclosure. In some examples, the process flow 500 may be implemented by, or may implement aspects of, the wireless communications system 100, the signaling diagrams 200 and 300, and the resource diagram 400. For example, the process flow 500 includes a network entity 105-c, an NCR 505, a UE 115-c, and a UE 115-d, which may be examples of the corresponding devices described with reference to FIGS. 1, 2, and 3. Following the process flow 500, the NCR 505 may selectively forward paging messages from the network entity 105-c to the UE 115-c, the UE 115-d, or both while operating in an enhanced idle mode. Alternative examples of the following may be implemented, where some steps are performed in a different order than described or are not performed at all. In some cases, steps may include additional features not mentioned below, or further steps may be added. Although the UE 115-c, the UE 115-d, the NCR 505, and the network entity 105-c are shown performing the operations of the process flow 500, some aspects of some operations may also be performed by one or more other wireless devices.

In some examples, the NCR 505 (e.g., via the NCR-MT) may transmit, and the network entity 105-c may receive or obtain, a capability information message indicating that the NCR 505 supports the enhanced idle mode with intelligent forwarding described in the present disclosure. For example, the capability information message may indicate, to the network entity 105-c, that the NCR 505 may selectively forward one or more messages from the network entity 105-c to the UE 115-c, the UE 115-d, or both.

At 510, the NCR 505 may enter an idle mode (e.g., an enhanced idle mode) at a first radio (e.g., an NCR-MT) associated with the NCR 505. For example, the NCR 505 may refrain from monitoring for one or more messages from the network entity 105-c while in the idle mode to save power at the NCR 505. The NCR 505 may periodically wake up to monitor for one or more messages from the network entity 105-c at a time or times configured by the network entity 105-c prior to entering the idle mode (e.g., via RRC signaling, MAC-CE, system information, or dynamic physical layer signaling). For example, the NCR 505 may monitor for the PEI received at 520, the DCI received at 530, and the PDSCH received at 545 while in the idle mode.

At 515, the UE 115-c, the UE 115-d, neither, or both may enter an idle mode. For example, the UE 115-c, the UE 115-d, or both may refrain from monitoring for one or more messages forwarded by the NCR 505, and may periodically wake up to monitor for one or more messages forwarded by the NCR 505 (e.g., at one or more paging occasions or one or more PDCCH monitoring occasions). In some cases, the UE 115-c, the UE 115-d, or both may monitor for the PEI at 525, the DCI at 540, the PDSCH at 550, or any combination thereof.

At 520, the network entity 105-c may output (e.g., transmit), and the NCR 505 may receive, one or more transmissions of a PEI during a paging occasion of a paging frame while the first radio is in the idle mode. In some examples, the PEI may indicate one or more UE IDs or group IDs. For example, the PEI may indicate an ID associated with the UE 115-c, the UE 115-d, or both. In another example, the PEI may indicate a group ID associated with the UE 115-c, the UE 115-d, or both. In some examples, the PEI may indicate that the network entity 105-c is to transmit a DCI at 530.

At 525, the NCR 505 may forward, via a second radio (e.g., an NCR-FWD) associated with the NCR 505 and to the UE 115-c, the UE 115-d, or both, the one or more transmissions of the PEI during the paging occasion of the paging frame while the first radio is in the idle mode. For example, the NCR 505 may forward the PEI to the UE 115-c based on the PEI including a UE ID or group ID associated with the UE 115-c. The PEI may indicate that the UE is to monitor for a DCI at 540.

At 530, the network entity 105-c may output (e.g., transmit), and the NCR 505 may receive, a DCI during the paging occasion of the paging frame or a subsequent paging occasion of a paging frame while the first radio is in the idle mode. In some examples, the NCR 505 may monitor for the DCI at 530 based on the PEI received at 520 including an indication that the network entity 105-c was to transmit the DCI at 530.

At 535, the NCR 505 may stay awake for a defined quantity of symbols or slots to detect and decode the DCI received at 530. For example, if the NCR 505 does not successfully decode the DCI during the defined quantity of symbols or slots, the UE may not monitor for the PDSCH at 545 or forward the PDSCH at 550.

At 540, the NCR 505 may forward, via the second radio associated with the NCR 505 and to the UE 115-c, the UE 115-d, or both, the one or more transmissions of the DCI during the paging occasion of the paging frame or the subsequent paging occasion of the paging frame while the first radio is in the idle mode. The NCR 505 may forward the DCI at 540 based on successfully decoding the DCI at 530. In some examples, the NCR 505 may selectively forward the DCI to the UE 115-c on a first beam and may selectively forward the DCI to UE 115-d on a second beam. In some examples, the NCR 550 may forward the DCI to the UE 115-d a defined offset value (e.g., K slots) after forwarding the DCI to the UE 115-c.

At 545, the network entity 105-c may output (e.g., transmit), and the NCR 505 may receive, one or more paging messages or PDSCH transmissions during a set quantity of symbols of the paging frame subsequent to the paging occasion while the first radio is in the idle mode. For example, the NCR 505 may monitor for and receive the PDSCH at 545 based on successfully receiving the PEI at 520, successfully decoding the DCI at 530, or both.

At 550, the NCR 505 may selectively forward, via the second radio associated with the NCR 505, the one or more paging messages or PDSCH transmissions during the set quantity of symbols of the paging frame subsequent to the paging occasion while the first radio is in the idle mode. The selective forwarding may be based on successfully decoding the DCI at 530 or the PEI at 520 at the NCR 505. In some examples, the NCR 505 may unconditionally forward one or more paging messages or PDSCH transmissions associated with one or more symbols of the set quantity of symbols of the paging frame based on an ID (e.g., a UE ID) associated with the first radio of the NCR.

In some examples, the NCR 505 may selectively forward, via the second radio and during the set quantity of symbols of the paging frame subsequent to the paging occasion, the one or more paging messages or PDSCH transmissions on a first beam. The NCR 505 may selectively forward, via the second radio and during a second set quantity of symbols of the paging frame subsequent to the paging occasion, a retransmission of the one or more paging messages or PDSCH transmissions on a second beam. The second set quantity of symbols of the paging frame may be separated from the set quantity of symbols of the paging frame by a defined offset value (e.g., a quantity of slots or symbols), as described in more detail with reference to FIG. 3. In some examples, the NCR 505 may receive (e.g., from the network entity 105-c) an indication of the defined offset value. In some examples, the NCR 505 may forward one or more paging occasions associated with one or more respective group IDs indicated by the PEI at 520. Each of the one or more respective group IDs may identify a group of UEs 115 connected to the NCR 505 via an access link. For example, the UE 115-c and the UE 115-d may be identified by a same group ID, and the NCR 505 may forward one or more paging occasions to the UE 115-c and the UE 115-d based on that same group ID.

In some examples, one or more UEs 115 that share a same group ID may receive one or more transmissions from the NCR 505 via a same beam. In some examples, the NCR 505 may receive (e.g., from the network entity 105-c) an indication of one or more IDs associated with one or more UEs (e.g., the UE 115-c and the UE 115-d). The one or more paging messages of PDSCH transmissions may be selectively forwarded to the UE 115-c, the UE 115-d, or both based on the ID associated with the first radio of the NCR 505 and based on one or more IDs associated with the UE 115-c, the UE 115-d, or both. In some examples, the one or more IDs may include a set of discrete IDs (e.g., UE 115-c and UE 115-d). In some examples, the one or more IDs may include a range of IDs from a minimum value to a maximum value (e.g., UE 115-a through UE 115-d). In some examples, the PEI received by the NCR 505 at 520 may indicate a subset of the one or more IDs, and the NCR 505 may selectively forward (e.g., at 550) one or more paging occasions associated with the subset of the one or more IDs indicated by the PEI.

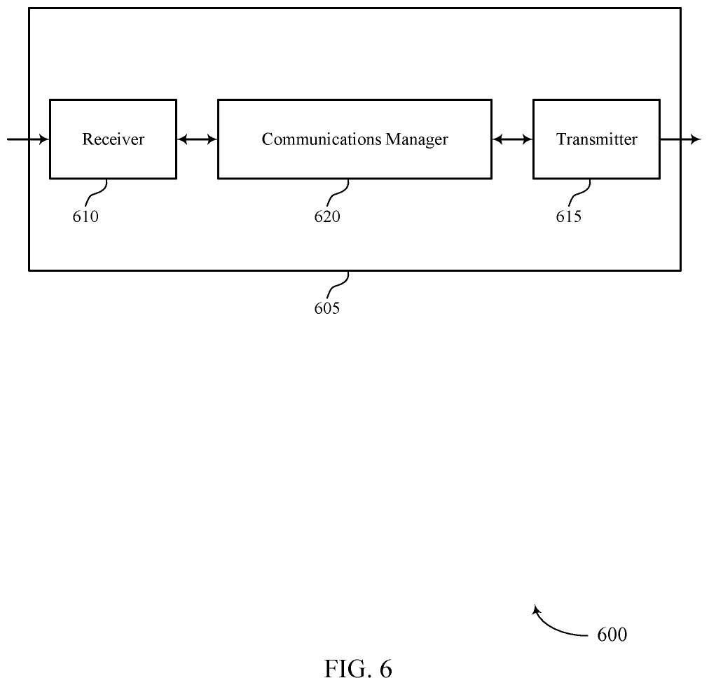

FIG. 6 shows a block diagram 600 of a device 605 that supports enhanced idle mode behavior of NCRs in accordance with one or more aspects of the present disclosure. The device 605 may be an example of aspects of an NCR as described herein. The device 605 may include a receiver 610, a transmitter 615, and a communications manager 620. The device 605, or one or more components of the device 605 (e.g., the receiver 610, the transmitter 615, the communications manager 620), may include at least one processor, which may be coupled with at least one memory, to, individually or collectively, support or enable the described techniques. Each of these components may be in communication with one another (e.g., via one or more buses).

The receiver 610 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 605. In some examples, the receiver 610 may support obtaining information by receiving signals via one or more antennas. Additionally, or alternatively, the receiver 610 may support obtaining information by receiving signals via one or more wired (e.g., electrical, fiber optic) interfaces, wireless interfaces, or any combination thereof.

The transmitter 615 may provide a means for outputting (e.g., transmitting, providing, conveying, sending) information generated by other components of the device 605. For example, the transmitter 615 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 615 may support outputting information by transmitting signals via one or more antennas. Additionally, or alternatively, the transmitter 615 may support outputting information by transmitting signals via one or more wired (e.g., electrical, fiber optic) interfaces, wireless interfaces, or any combination thereof. In some examples, the transmitter 615 and the receiver 610 may be co-located in a transceiver, which may include or be coupled with a modem.

The communications manager 620, the receiver 610, the transmitter 615, or various combinations or components thereof may be examples of means for performing various aspects of enhanced idle mode behavior of NCRs as described herein. For example, the communications manager 620, the receiver 610, the transmitter 615, or various combinations or components thereof may be capable of performing one or more of the functions described herein.

In some examples, the communications manager 620, the receiver 610, the transmitter 615, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 620, the receiver 610, the transmitter 615, or various combinations or components thereof may be implemented in code (e.g., as communications management software or firmware) executed by at least one processor (e.g., referred to as a processor-executable code). If implemented in code executed by at least one processor, the functions of the communications manager 620, the receiver 610, the transmitter 615, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 620 may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communications in accordance with examples as disclosed herein. For example, the communications manager 620 is capable of, configured to, or operable to support a means for entering an idle mode at a first radio associated with the NCR. The communications manager 620 is capable of, configured to, or operable to support a means for forwarding, via a second radio associating with the NCR, one or more transmissions of a DCI, a PEI, or both during a paging occasion of a paging frame while the first radio is in the idle mode. The communications manager 620 is capable of, configured to, or operable to support a means for selectively forwarding, via the second radio associated with the NCR, one or more paging messages or PDSCH transmissions during a set quantity of symbols of the paging frame subsequent to the paging occasion while the first radio is in the idle mode, the selective forwarding being based on successfully decoding the DCI or the PEI at the NCR.

By including or configuring the communications manager 620 in accordance with examples as described herein, the device 605 (e.g., at least one processor controlling or otherwise coupled with the receiver 610, the transmitter 615, the communications manager 620, or a combination thereof) may support techniques for reduced power consumption and more efficient utilization of communication resources.

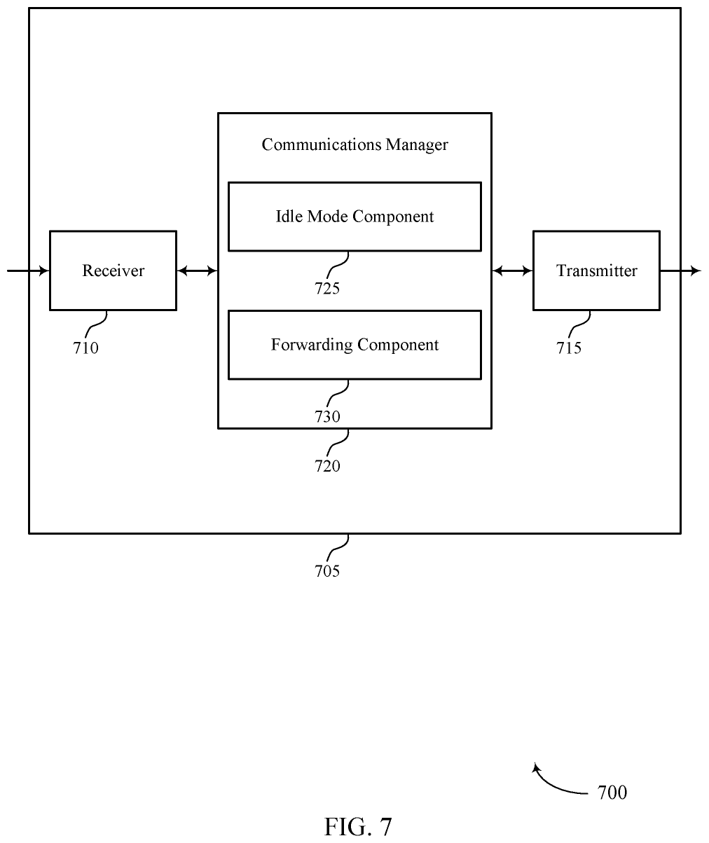

FIG. 7 shows a block diagram 700 of a device 705 that supports enhanced idle mode behavior of NCRs in accordance with one or more aspects of the present disclosure. The device 705 may be an example of aspects of a device 605 or an NCR 205, 305, or 505 as described herein. The device 705 may include a receiver 710, a transmitter 715, and a communications manager 720. The device 705, or one or more components of the device 705 (e.g., the receiver 710, the transmitter 715, the communications manager 720), may include at least one processor, which may be coupled with at least one memory, to support the described techniques. Each of these components may be in communication with one another (e.g., via one or more buses).

The receiver 710 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 705. In some examples, the receiver 710 may support obtaining information by receiving signals via one or more antennas. Additionally, or alternatively, the receiver 710 may support obtaining information by receiving signals via one or more wired (e.g., electrical, fiber optic) interfaces, wireless interfaces, or any combination thereof.

The transmitter 715 may provide a means for outputting (e.g., transmitting, providing, conveying, sending) information generated by other components of the device 705. For example, the transmitter 715 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 715 may support outputting information by transmitting signals via one or more antennas. Additionally, or alternatively, the transmitter 715 may support outputting information by transmitting signals via one or more wired (e.g., electrical, fiber optic) interfaces, wireless interfaces, or any combination thereof. In some examples, the transmitter 715 and the receiver 710 may be co-located in a transceiver, which may include or be coupled with a modem.

The device 705, or various components thereof, may be an example of means for performing various aspects of enhanced idle mode behavior of NCRs as described herein. For example, the communications manager 720 may include an idle mode component 725 a forwarding component 730, or any combination thereof. The communications manager 720 may be an example of aspects of a communications manager 620 as described herein. In some examples, the communications manager 720, or various components thereof, may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The communications manager 720 may support wireless communications in accordance with examples as disclosed herein. The idle mode component 725 is capable of, configured to, or operable to support a means for entering an idle mode at a first radio associated with the NCR. The forwarding component 730 is capable of, configured to, or operable to support a means for forwarding, via a second radio associated with the NCR, one or more transmissions of a DCI, a PEI, or both during a paging occasion of a paging frame while the first radio is in the idle mode. The forwarding component 730 is capable of, configured to, or operable to support a means for selectively forwarding, via the second radio associated with the NCR, one or more paging messages or PDSCH transmissions during a set quantity of symbols of the paging frame subsequent to the paging occasion while the first radio is in the idle mode, the selective forwarding being based on successfully decoding the DCI or the PEI at the NCR.

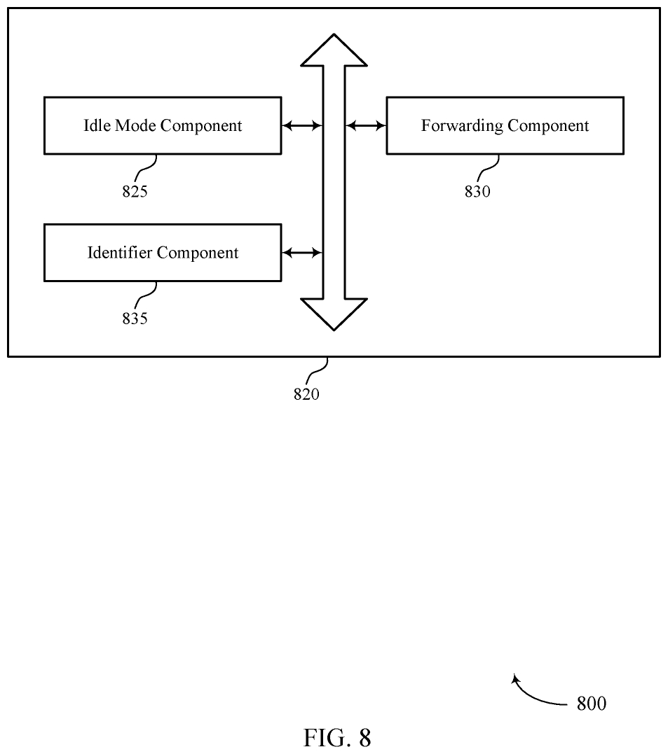

FIG. 8 shows a block diagram 800 of a communications manager 820 that supports enhanced idle mode behavior of NCRs in accordance with one or more aspects of the present disclosure. The communications manager 820 may be an example of aspects of a communications manager 620, a communications manager 720, or both, as described herein. The communications manager 820, or various components thereof, may be an example of means for performing various aspects of enhanced idle mode behavior of NCRs as described herein. For example, the communications manager 820 may include an idle mode component 825, a forwarding component 830, an ID component 835, or any combination thereof. Each of these components, or components or subcomponents thereof (e.g., one or more processors, one or more memories), may communicate, directly or indirectly, with one another (e.g., via one or more buses).

The communications manager 820 may support wireless communications in accordance with examples as disclosed herein. The idle mode component 825 is capable of, configured to, or operable to support a means for entering an idle mode at a first radio associated with the NCR. The forwarding component 830 is capable of, configured to, or operable to support a means for forwarding, via a second radio associated with the NCR, one or more transmissions of a DCI, a PEI, or both during a paging occasion of a paging frame while the first radio is in the idle mode. In some examples, the forwarding component 830 is capable of, configured to, or operable to support a means for selectively forwarding, via the second radio associated with the NCR, one or more paging messages or PDSCH transmissions during a set quantity of symbols of the paging frame subsequent to the paging occasion while the first radio is in the idle mode, the selective forwarding being based on successfully decoding the DCI or the PEI at the NCR.

In some examples, to support selectively forwarding the one or more paging messages or PDSCH transmissions, the forwarding component 830 is capable of, configured to, or operable to support a means for unconditionally forwarding one or more paging messages or PDSCH transmissions associated with one or more symbols of the set quantity of symbols of the paging frame based on an ID associated with the first radio of the NCR.

In some examples, the ID component 835 is capable of, configured to, or operable to support a means for receiving an indication of one or more IDs associated with one or more UEs.

In some examples, the one or more paging messages or PDSCH transmissions are selectively forwarded to the one or more UEs based on an ID associated with the first radio of the NCR and based on one or more IDs associated with the one or more respective UEs.

In some examples, the one or more IDs includes a set of discrete IDs.

In some examples, the one or more IDs includes a range of UE IDs from a minimum value to a maximum value.

In some examples, the ID component 835 is capable of, configured to, or operable to support a means for receiving, based on receiving the indication of the one or more IDs, a PEI indicating a subset of the one or more IDs. In some examples, the forwarding component 830 is capable of, configured to, or operable to support a means for selectively forwarding one or more paging occasions associated with the subset of the one or more IDs indicated by the PEI.

In some examples, to support selectively forwarding the one or more paging messages or PDSCH transmissions, the forwarding component 830 is capable of, configured to, or operable to support a means for selectively forwarding, via the second radio and during the set quantity of symbols of the paging frame subsequent to the paging occasion, the one or more paging messages or PDSCH transmissions on a first beam. In some examples, to support selectively forwarding the one or more paging messages or PDSCH transmissions, the forwarding component 830 is capable of, configured to, or operable to support a means for selectively forwarding, via the second radio and during a second set quantity of symbols of the paging frame subsequent to the paging occasion, a retransmission of the one or more paging messages or PDSCH transmissions on a second beam.

In some examples, the second set quantity of symbols of the paging frame is separated from the set quantity of symbols of the paging frame by a defined offset value.

In some examples, the forwarding component 830 is capable of, configured to, or operable to support a means for receiving an indication of the defined offset value.

In some examples, the forwarding component 830 is capable of, configured to, or operable to support a means for forwarding one or more paging occasions associated with one or more respective group IDs indicated by the PEI, where each of the one or more respective group IDs identifies a group of UEs connected to the NCR via an access link.

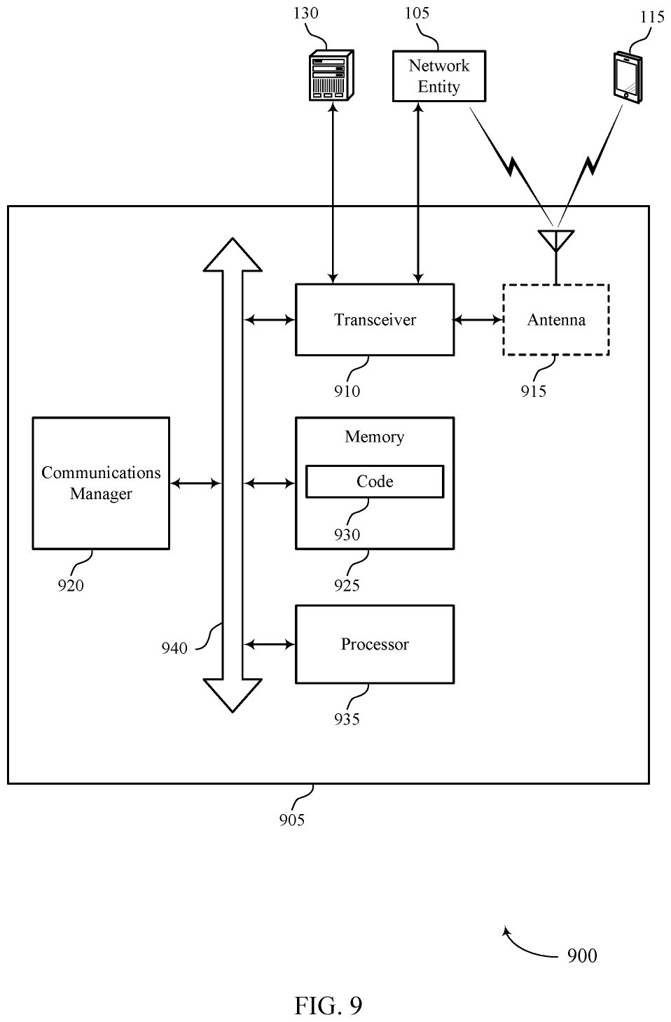

FIG. 9 shows a diagram of a system 900 including a device 905 that supports enhanced idle mode behavior of NCRs in accordance with one or more aspects of the present disclosure. The device 905 may be an example of or include components of a device 605, a device 705, or an NCR as described herein. The device 905 may include components for bi-directional voice and data communications including components for transmitting and receiving communications, such as a communications manager 920, a transceiver 910, one or more antennas 915, at least one memory 925, code 930, and at least one processor 935. These components may be in electronic communication or otherwise coupled (e.g., operatively, communicatively, functionally, electronically, electrically) via one or more buses (e.g., a bus 940).

The transceiver 910 may support bi-directional communications via wired links, wireless links, or both as described herein. In some examples, the transceiver 910 may include a wired transceiver and may communicate bi-directionally with another wired transceiver. Additionally, or alternatively, in some examples, the transceiver 910 may include a wireless transceiver and may communicate bi-directionally with another wireless transceiver. In some examples, the device 905 may include one or more antennas 915, which may be capable of transmitting or receiving wireless transmissions (e.g., concurrently). The transceiver 910 may also include a modem to modulate signals, to provide the modulated signals for transmission (e.g., by one or more antennas 915, by a wired transmitter), to receive modulated signals (e.g., from one or more antennas 915, from a wired receiver), and to demodulate signals. In some implementations, the transceiver 910 may include one or more interfaces, such as one or more interfaces coupled with the one or more antennas 915 that are configured to support various receiving or obtaining operations, or one or more interfaces coupled with the one or more antennas 915 that are configured to support various transmitting or outputting operations, or a combination thereof. In some implementations, the transceiver 910 may include or be configured for coupling with one or more processors or one or more memory components that are operable to perform or support operations based on received or obtained information or signals, or to generate information or other signals for transmission or other outputting, or any combination thereof. In some implementations, the transceiver 910, or the transceiver 910 and the one or more antennas 915, or the transceiver 910 and the one or more antennas 915 and one or more processors or one or more memory components (e.g., the at least one processor 935, the at least one memory 925, or both), may be included in a chip or chip assembly that is installed in the device 905. In some examples, the transceiver 910 may be operable to support communications via one or more communications links (e.g., communication link(s) 125, backhaul communication link(s) 120, a midhaul communication link 162, a fronthaul communication link 168).

The at least one memory 925 may include RAM, ROM, or any combination thereof. The at least one memory 925 may store computer-readable, computer-executable, or processor-executable code, such as the code 930. The code 930 may include instructions that, when executed by one or more of the at least one processor 935, cause the device 905 to perform various functions described herein. The code 930 may be stored in a non-transitory computer-readable medium such as system memory or another type of memory. In some cases, the code 930 may not be directly executable by a processor of the at least one processor 935 but may cause a computer (e.g., when compiled and executed) to perform functions described herein. In some cases, the at least one memory 925 may include, among other things, a BIOS which may control basic hardware or software operation such as the interaction with peripheral components or devices. In some examples, the at least one processor 935 may include multiple processors and the at least one memory 925 may include multiple memories. One or more of the multiple processors may be coupled with one or more of the multiple memories which may, individually or collectively, be configured to perform various functions herein (for example, as part of a processing system).

The at least one processor 935 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 935 may be configured to operate a memory array using a memory controller. In some other cases, a memory controller may be integrated into one or more of the at least one processor 935. The at least one processor 935 may be configured to execute computer-readable instructions stored in a memory (e.g., one or more of the at least one memory 925) to cause the device 905 to perform various functions (e.g., functions or tasks supporting enhanced idle mode behavior of NCRs). For example, the device 905 or a component of the device 905 may include at least one processor 935 and at least one memory 925 coupled with one or more of the at least one processor 935, the at least one processor 935 and the at least one memory 925 configured to perform various functions described herein. The at least one processor 935 may be an example of a cloud-computing platform (e.g., one or more physical nodes and supporting software such as operating systems, virtual machines, or container instances) that may host the functions (e.g., by executing code 930) to perform the functions of the device 905. The at least one processor 935 may be any one or more suitable processors capable of executing scripts or instructions of one or more software programs stored in the device 905 (such as within one or more of the at least one memory 925).

In some examples, the at least one processor 935 may include multiple processors and the at least one memory 925 may include multiple memories. One or more of the multiple processors may be coupled with one or more of the multiple memories, which may, individually or collectively, be configured to perform various functions herein. In some examples, the at least one processor 935 may be a component of a processing system, which may refer to a system (such as a series) of machines, circuitry (including, for example, one or both of processor circuitry (which may include the at least one processor 935) and memory circuitry (which may include the at least one memory 925)), or components, that receives or obtains inputs and processes the inputs to produce, generate, or obtain a set of outputs. The processing system may be configured to perform one or more of the functions described herein. For example, the at least one processor 935 or a processing system including the at least one processor 935 may be configured to, configurable to, or operable to cause the device 905 to perform one or more of the functions described herein. Further, as described herein, being “configured to,” being “configurable to,” and being “operable to” may be used interchangeably and may be associated with a capability, when executing code stored in the at least one memory 925 or otherwise, to perform one or more of the functions described herein.

In some examples, a bus 940 may support communications of (e.g., within) a protocol layer of a protocol stack. In some examples, a bus 940 may support communications associated with a logical channel of a protocol stack (e.g., between protocol layers of a protocol stack), which may include communications performed within a component of the device 905, or between different components of the device 905 that may be co-located or located in different locations (e.g., where the device 905 may refer to a system in which one or more of the communications manager 920, the transceiver 910, the at least one memory 925, the code 930, and the at least one processor 935 may be located in one of the different components or divided between different components).

In some examples, the communications manager 920 may manage aspects of communications with a core network 130 (e.g., via one or more wired or wireless backhaul links). For example, the communications manager 920 may manage the transfer of data communications for client devices, such as one or more UEs 115. In some examples, the communications manager 920 may manage communications with one or more other network entities 105, and may include a controller or scheduler for controlling communications with UEs 115 (e.g., in cooperation with the one or more other network devices). In some examples, the communications manager 920 may support an X2 interface within an LTE/LTE-A wireless communications network technology to provide communication between network entities 105.

The communications manager 920 may support wireless communications in accordance with examples as disclosed herein. For example, the communications manager 920 is capable of, configured to, or operable to support a means for entering an idle mode at a first radio associated with the NCR. The communications manager 920 is capable of, configured to, or operable to support a means for forwarding, via a second radio associating with the NCR, one or more transmissions of a DCI, a PEI, or both during a paging occasion of a paging frame while the first radio is in the idle mode. The communications manager 920 is capable of, configured to, or operable to support a means for selectively forwarding, via the second radio associated with the NCR, one or more paging messages or PDSCH transmissions during a set quantity of symbols of the paging frame subsequent to the paging occasion while the first radio is in the idle mode, the selective forwarding being based on successfully decoding the DCI or the PEI at the NCR.

By including or configuring the communications manager 920 in accordance with examples as described herein, the device 905 may support techniques for reduced latency, reduced power consumption, more efficient utilization of communication resources, improved coordination between devices, and longer battery life.

In some examples, the communications manager 920 may be configured to perform various operations (e.g., receiving, obtaining, monitoring, outputting, transmitting) using or otherwise in cooperation with the transceiver 910, the one or more antennas 915 (e.g., where applicable), or any combination thereof. Although the communications manager 920 is illustrated as a separate component, in some examples, one or more functions described with reference to the communications manager 920 may be supported by or performed by the transceiver 910, one or more of the at least one processor 935, one or more of the at least one memory 925, the code 930, or any combination thereof (for example, by a processing system including at least a portion of the at least one processor 935, the at least one memory 925, the code 930, or any combination thereof). For example, the code 930 may include instructions executable by one or more of the at least one processor 935 to cause the device 905 to perform various aspects of enhanced idle mode behavior of NCRs as described herein, or the at least one processor 935 and the at least one memory 925 may be otherwise configured to, individually or collectively, perform or support such operations.

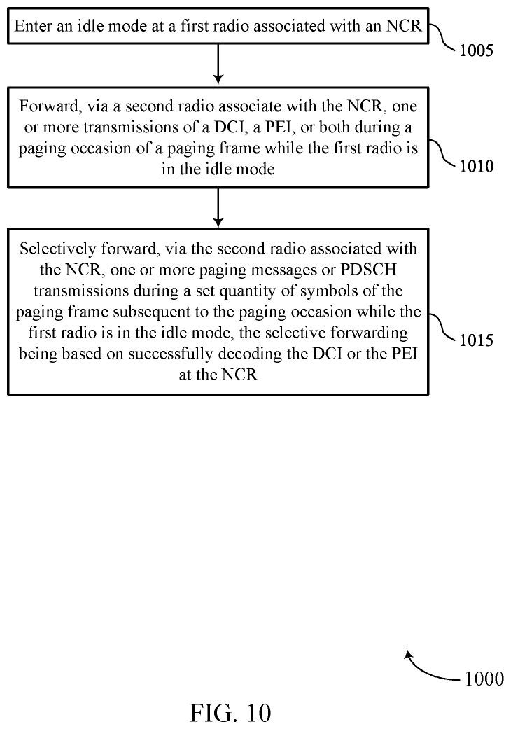

FIG. 10 shows a flowchart illustrating a method 1000 that supports enhanced idle mode behavior of NCRs in accordance with one or more aspects of the present disclosure. The operations of the method 1000 may be implemented by an NCR or its components as described herein. For example, the operations of the method 1000 may be performed by an NCR as described with reference to FIGS. 1 through 9. In some examples, an NCR may execute a set of instructions to control the functional elements of the NCR to perform the described functions. Additionally, or alternatively, the NCR may perform aspects of the described functions using special-purpose hardware.

At 1005, the method may include entering an idle mode at a first radio associated with the NCR. The operations of 1005 may be performed in accordance with examples as disclosed herein. In some examples, aspects of the operations of 1005 may be performed by an idle mode component 825 as described with reference to FIG. 8.

At 1010, the method may include forwarding, via a second radio associated with the NCR, one or more transmissions of a DCI, a PEI, or both during a paging occasion of a paging frame while the first radio is in the idle mode. The operations of 1010 may be performed in accordance with examples as disclosed herein. In some examples, aspects of the operations of 1010 may be performed by a forwarding component 830 as described with reference to FIG. 8.

At 1015, the method may include selectively forwarding, via the second radio associated with the NCR, one or more paging messages or PDSCH transmissions during a set quantity of symbols of the paging frame subsequent to the paging occasion while the first radio is in the idle mode, the selective forwarding being based on successfully decoding the DCI or the PEI at the NCR. The operations of 1015 may be performed in accordance with examples as disclosed herein. In some examples, aspects of the operations of 1015 may be performed by a forwarding component 830 as described with reference to FIG. 8.

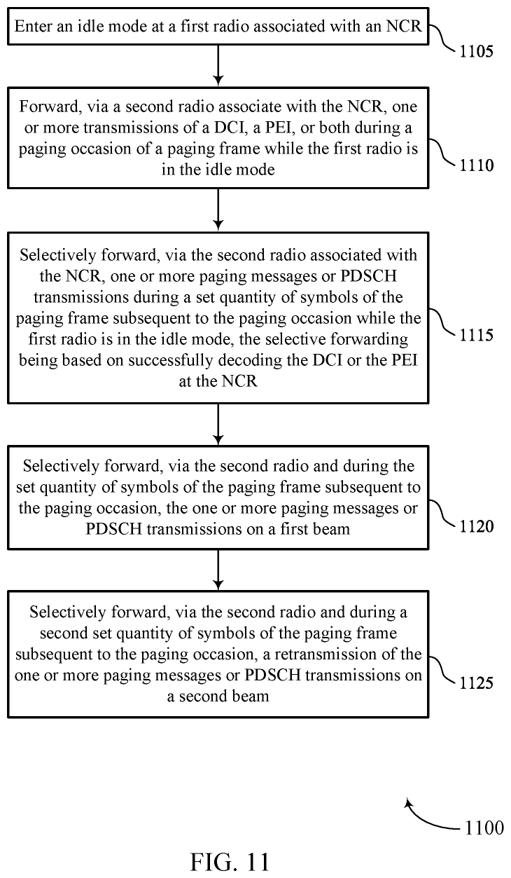

FIG. 11 shows a flowchart illustrating a method 1100 that supports enhanced idle mode behavior of NCRs in accordance with one or more aspects of the present disclosure. The operations of the method 1100 may be implemented by an NCR or its components as described herein. For example, the operations of the method 1100 may be performed by an NCR as described with reference to FIGS. 1 through 9. In some examples, an NCR may execute a set of instructions to control the functional elements of the NCR to perform the described functions. Additionally, or alternatively, the NCR may perform aspects of the described functions using special-purpose hardware.

At 1105, the method may include entering an idle mode at a first radio associated with the NCR. The operations of 1105 may be performed in accordance with examples as disclosed herein. In some examples, aspects of the operations of 1105 may be performed by an idle mode component 825 as described with reference to FIG. 8.

At 1110, the method may include forwarding, via a second radio associated with the NCR, one or more transmissions of a DCI, a PEI, or both during a paging occasion of a paging frame while the first radio is in the idle mode. The operations of 1110 may be performed in accordance with examples as disclosed herein. In some examples, aspects of the operations of 1110 may be performed by a forwarding component 830 as described with reference to FIG. 8.

At 1115, the method may include selectively forwarding, via the second radio associated with the NCR, one or more paging messages or PDSCH transmissions during a set quantity of symbols of the paging frame subsequent to the paging occasion while the first radio is in the idle mode, the selective forwarding being based on successfully decoding the DCI or the PEI at the NCR. The operations of 1115 may be performed in accordance with examples as disclosed herein. In some examples, aspects of the operations of 1115 may be performed by a forwarding component 830 as described with reference to FIG. 8.

At 1120, the method may include selectively forwarding, via the second radio and during the set quantity of symbols of the paging frame subsequent to the paging occasion, the one or more paging messages or PDSCH transmissions on a first beam. The operations of 1120 may be performed in accordance with examples as disclosed herein. In some examples, aspects of the operations of 1120 may be performed by a forwarding component 830 as described with reference to FIG. 8.

At 1125, the method may include selectively forwarding, via the second radio and during a second set quantity of symbols of the paging frame subsequent to the paging occasion, a retransmission of the one or more paging messages or PDSCH transmissions on a second beam. The operations of 1125 may be performed in accordance with examples as disclosed herein. In some examples, aspects of the operations of 1125 may be performed by a forwarding component 830 as described with reference to FIG. 8.

The following aspects are given by way of illustration. Examples of the following aspects may be combined with examples or embodiments shown or discussed in relation to the figures or elsewhere herein.

Aspect 1: A method for wireless communications at an NCR, comprising: entering an idle mode at a first radio associated with the NCR; forwarding, via a second radio associated with the NCR, one or more transmissions of a DCI, a PEI, or both during a paging occasion of a paging frame while the first radio is in the idle mode; and selectively forwarding, via the second radio associated with the NCR, one or more paging messages or PDSCH transmissions during a set quantity of symbols of the paging frame subsequent to the paging occasion while the first radio is in the idle mode, the selective forwarding being based at least in part on successfully decoding the DCI or the PEI at the NCR.

Aspect 2: The method of aspect 1, wherein selectively forwarding the one or more paging messages or PDSCH transmissions comprises: unconditionally forwarding one or more paging messages or PDSCH transmissions associated with one or more symbols of the set quantity of symbols of the paging frame based at least in part on an identifier associated with the first radio of the NCR.

Aspect 3: The method of any of aspects 1 through 2, further comprising: receiving an indication of one or more identifiers associated with one or more UEs.

Aspect 4: The method of aspect 3, wherein the one or more paging messages or PDSCH transmissions are selectively forwarded to the one or more UEs based at least in part on an identifier associated with the first radio of the NCR and based at least in part on one or more identifiers associated with the one or more respective UEs.

Aspect 5: The method of any of aspects 3 through 4, wherein the one or more identifiers includes a set of discrete identifiers.

Aspect 6: The method of any of aspects 3 through 5, wherein the one or more identifiers includes a range of UE identifiers from a minimum value to a maximum value.

Aspect 7: The method of any of aspects 3 through 6, further comprising: receiving, based at least in part on receiving the indication of the one or more identifiers, a PEI indicating a subset of the one or more identifiers; and selectively forwarding one or more paging occasions associated with the subset of the one or more identifiers indicated by the PEI.

Aspect 8: The method of any of aspects 1 through 7, wherein selectively forwarding the one or more paging messages or PDSCH transmissions comprises: selectively forwarding, via the second radio and during the set quantity of symbols of the paging frame subsequent to the paging occasion, the one or more paging messages or PDSCH transmissions on a first beam; and selectively forwarding, via the second radio and during a second set quantity of symbols of the paging frame subsequent to the paging occasion, a retransmission of the one or more paging messages or PDSCH transmissions on a second beam.

Aspect 9: The method of aspect 8, wherein the second set quantity of symbols of the paging frame is separated from the set quantity of symbols of the paging frame by a defined offset value.

Aspect 10: The method of aspect 9, further comprising: receiving an indication of the defined offset value.

Aspect 11: The method of any of aspects 1 through 10, further comprising: forwarding one or more paging occasions associated with one or more respective group identifiers indicated by the PEI, wherein each of the one or more respective group identifiers identifies a group of UEs connected to the NCR via an access link.

Aspect 12: An NCR for wireless communications, comprising one or more memories storing processor-executable code, and one or more processors coupled with the one or more memories and individually or collectively operable to execute the code to cause the NCR to perform a method of any of aspects 1 through 11.

Aspect 13: An NCR for wireless communications, comprising at least one means for performing a method of any of aspects 1 through 11.

Aspect 14: A non-transitory computer-readable medium storing code for wireless communications, the code comprising instructions executable by one or more processors to perform a method of any of aspects 1 through 11.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A network-controlled repeater, comprising:
one or more memories storing processor-executable code; and
one or more processors coupled with the one or more memories and individually or collectively operable to execute the code to cause the network-controlled repeater to:
enter an idle mode at a first radio associated with the network-controlled repeater;
forward via a second radio associated with the network-controlled repeater, one or more transmissions of a downlink control information (DCI), a paging early indication (PEI), or both during a paging occasion of a paging frame while the first radio is in the idle mode; and
selectively forward, via the second radio associated with the network-controlled repeater, one or more paging messages or physical downlink shared channel (PDSCH) transmissions during a set quantity of symbols of the paging frame subsequent to the paging occasion while the first radio is in the idle mode, the selective forwarding being based at least in part on successfully decoding the DCI or the PEI at the network-controlled repeater.

2. The network-controlled repeater of claim 1, wherein, to selectively forward the one or more paging messages or PDSCH transmissions, the one or more processors are individually or collectively operable to execute the code to cause the network-controlled repeater to:
unconditionally forward one or more paging messages or PDSCH transmissions associated with one or more symbols of the set quantity of symbols of the paging frame based at least in part on an identifier associated with the first radio of the network-controlled repeater.

3. The network-controlled repeater of claim 1, wherein the one or more processors are individually or collectively further operable to execute the code to cause the network-controlled repeater to:
receive an indication of one or more identifiers associated with one or more user equipments (UEs).

4. The network-controlled repeater of claim 3, wherein the one or more paging messages or PDSCH transmissions are selectively forwarded to the one or more UEs based at least in part on an identifier associated with the first radio of the network-controlled repeater and based at least in part on one or more identifiers associated with the one or more respective UEs.

5. The network-controlled repeater of claim 3, wherein the one or more identifiers includes a set of discrete identifiers.

6. The network-controlled repeater of claim 3, wherein the one or more identifiers includes a range of UE identifiers from a minimum value to a maximum value.

7. The network-controlled repeater of claim 3, wherein the one or more processors are individually or collectively further operable to execute the code to cause the network-controlled repeater to:
receive, based at least in part on receiving the indication of the one or more identifiers, a PEI indicating a subset of the one or more identifiers; and
selectively forward one or more paging occasions associated with the subset of the one or more identifiers indicated by the PEI.

8. The network-controlled repeater of claim 1, wherein, to selectively forward the one or more paging messages or PDSCH transmissions, the one or more processors are individually or collectively operable to execute the code to cause the network-controlled repeater to:
selectively forward, via the second radio and during the set quantity of symbols of the paging frame subsequent to the paging occasion, the one or more paging messages or PDSCH transmissions on a first beam; and
selectively forward, via the second radio and during a second set quantity of symbols of the paging frame subsequent to the paging occasion, a retransmission of the one or more paging messages or PDSCH transmissions on a second beam.

9. The network-controlled repeater of claim 8, wherein the second set quantity of symbols of the paging frame is separated from the set quantity of symbols of the paging frame by a defined offset value.

10. The network-controlled repeater of claim 9, wherein the one or more processors are individually or collectively further operable to execute the code to cause the network-controlled repeater to:
receive an indication of the defined offset value.

11. The network-controlled repeater of claim 1, wherein the one or more processors are individually or collectively further operable to execute the code to cause the network-controlled repeater to:
forward one or more paging occasions associated with one or more respective group identifiers indicated by the PEI, wherein each of the one or more respective group identifiers identifies a group of UEs connected to the network-controlled repeater via an access link.

12. A method for wireless communications at a network-controlled repeater, comprising:
entering an idle mode at a first radio associated with the network-controlled repeater;
forwarding, via a second radio associated with the network-controlled repeater, one or more transmissions of a downlink control information (DCI), a paging early indication (PEI), or both during a paging occasion of a paging frame while the first radio is in the idle mode; and
selectively forwarding, via the second radio associated with the network-controlled repeater, one or more paging messages or physical downlink shared channel (PDSCH) transmissions during a set quantity of symbols of the paging frame subsequent to the paging occasion while the first radio is in the idle mode, the selective forwarding being based at least in part on successfully decoding the DCI or the PEI at the network-controlled repeater.

13. The method of claim 12, wherein selectively forwarding the one or more paging messages or PDSCH transmissions comprises:
unconditionally forwarding one or more paging messages or PDSCH transmissions associated with one or more symbols of the set quantity of symbols of the paging frame based at least in part on an identifier associated with the first radio of the network-controlled repeater.

14. The method of claim 12, further comprising:
receiving an indication of one or more identifiers associated with one or more user equipments (UEs).

15. The method of claim 14, wherein the one or more paging messages or PDSCH transmissions are selectively forwarded to the one or more UEs based at least in part on an identifier associated with the first radio of the network-controlled repeater and based at least in part on one or more identifiers associated with the one or more respective UEs.

16. The method of claim 14, wherein the one or more identifiers includes a set of discrete identifiers.

17. The method of claim 14, wherein the one or more identifiers includes a range of UE identifiers from a minimum value to a maximum value.

18. The method of claim 14, further comprising:
receiving, based at least in part on receiving the indication of the one or more identifiers, a PEI indicating a subset of the one or more identifiers; and
selectively forwarding one or more paging occasions associated with the subset of the one or more identifiers indicated by the PEI.

19. The method of claim 12, wherein selectively forwarding the one or more paging messages or PDSCH transmissions comprises:
selectively forwarding, via the second radio and during the set quantity of symbols of the paging frame subsequent to the paging occasion, the one or more paging messages or PDSCH transmissions on a first beam; and
selectively forwarding, via the second radio and during a second set quantity of symbols of the paging frame subsequent to the paging occasion, a retransmission of the one or more paging messages or PDSCH transmissions on a second beam.

20. The method of claim 19, wherein the second set quantity of symbols of the paging frame is separated from the set quantity of symbols of the paging frame by a defined offset value.
